(19) United States
(12) Patent Application Publication
(10) Pub. No.: US 2006/0228684 A1
(43) Pub. Date: Oct. 12, 2006

(54) Digital wireless microphone having song selection and amplifier control functions in karaoke device, and karaoke system using the same

(75) Inventor: Jae Hwan Yoon, Seoul (KR)

Correspondence Address: LADAS & PARRY, 26 WEST 61ST STREET, NEW YORK, NY, 10023, US

(73) Assignee: TJ MEDIA CO., LTD.

(21) Appl. No.: 11/127,382

(22) Filed: May 12, 2005

(30) Foreign Application Priority Data
Apr. 6, 2005 (KR) 10-2005-28405

(51) Int. Cl. G10H 1/36; G10H 7/00

(52) U.S. Cl. 434/307 A

(57) ABSTRACT

The digital wireless microphone having song selection and amplifier control functions in a karaoke device, and a karaoke system using the same are disclosed. A clear voice signal can be outputted through a speaker without any frequency interference in such a manner that voice and operation signals are converted into a digital signal, and the converted digital signal is transmitted in a CDMA method using a spread code, and a user can easily set karaoke device and amplifier functions.

### BACKGROUND OF THE INVENTION

1. Field of the Invention

The present invention relates to a digital wireless microphone having song (title) selection and amplifier control functions in a karaoke device, and a karaoke system using the same, and in particular to a digital wireless microphone having song selection and amplifier control functions in a karaoke device, and a karaoke system using the same wherein a clear voice signal can be outputted through a speaker without any frequency interference in such a manner that voice and operation signals are converted into a digital signal, and the converted digital signal is transmitted in a CDMA method using a spread code, and a user can easily set karaoke device and amplifier functions.

2. Description of the Background Art

In a conventional karaoke device using a wireless microphone, an analog signal is generally transmitted at a frequency band of 88˜108 MHz or 700˜900 MHz when a user's voice signal is transmitted through a wireless microphone. Namely, an analog waveform (user's voice signal) is transmitted to a karaoke device using a UHF transmission and receiving module in a voice signal transmission method of a wireless microphone.

In addition, a transmission method using a UHF transmission and receiving module has been directly used in a portable karaoke system.

FIG. 1 is a block diagram illustrating an analog signal process device of a voice signal in a conventional wireless microphone karaoke system. As shown therein, the analog signal process device includes a wireless microphone 10 for modulating an analog waveform user's voice signal and transmitting to a karaoke device 20, a karaoke remote controller 30 for a song selection and a function control in a karaoke device, a wireless microphone receiver 40 for demodulating an analog waveform transmitted from the wireless microphone 10 and transmitting to the karaoke device 20, and a karaoke device 20 for outputting the user's analog voice transmitted from the wireless microphone receiver 40 through a speaker wherein the karaoke device 20 is controlled in accordance with a signal transmitted from the karaoke remote controller 30.

At this time, the wireless microphone 10 includes a microphone 11 for converting a voice signal of a user who is singing a song into an electrical signal, a voice signal UHF transmission module (UHF TX module) 12 for modulating an analog user's voice signal inputted through the microphone 11 and transmitting to a wireless microphone receiver 40.

The karaoke remote controller 30 includes a key input unit 31 for receiving a song selection data (namely, code) that a user wants to sing or a key signal for various function controls of the karaoke device 20, and an IR transmission module 32 for converting a key signal for a song selection data and a function control inputted through the key input unit 31 into an IR signal and transmitting to the karaoke device 20.

The wireless microphone receiver 40 includes an antenna 41 for receiving a voice signal, and a voice signal UHF receiving module (UHF RX module) 42 for demodulating an analog signal transmitted through the voice signal UHF transmission module (UHF TX module) of the wireless microphone 10 and outputting to a microphone input unit 21 of the karaoke device 20.

The karaoke device 20 includes an IR receiver 22 for receiving a key signal for a song selection data or a function control transmitted through the IR transmission module 32 of the karaoke remote controller 30 and outputting to a karaoke controller 25, a microphone input unit 21 for outputting a user's analog voice signal inputted from the wireless microphone receiver 40 to a mixer controller 24, a memory 23 for storing a title-based song source data, a karaoke controller 24 for controlling the whole operations of the karaoke device 20 and controlling a song playing and function setting of the karaoke device 20 in accordance with a key signal for a song selection data or a function control inputted from the IR receiver 22, and a mixer controller 24 for outputting a user's analog voice signal inputted from the microphone input unit 21 and a song-based sound source data stored in the memory 23 in accordance with a control of the karaoke controller 24.

The voice signal transmission process between the wireless microphone 10, the karaoke device 20 and the wireless microphone receiver 40 in the conventional art will be described. In addition, the key signal transmission process between the karaoke remote controller 30 and the karaoke device 20 will be also described.

The karaoke device 20 plays a certain sound source data of a song stored in the memory 23 in accordance with a selection data inputted by a user or a function setting key signal transmitted from the karaoke remote controller 30 or controls a function of the karaoke device 20.

When the sound source data of the song selected by the user is played, and the user sings the song, the voice signal UHF transmission module (UHF TX module) 12 of the wireless microphone 10 modulates a user's analog voice signal inputted from the microphone 11 and transmits to the wireless microphone receiver 40.

The voice signal UHF receiving module (UHF RX module) 42 of the wireless microphone receiver 40 receives and demodulates an analog signal transmitted from the voice signal UHF module (UHF TX module) 12 of the wireless microphone 10 and outputs to the microphone input unit 21 of the karaoke device 20.

The microphone input unit 21 receives a demodulated analog signal from the wireless microphone receiver 40, and the mixer controller 34 outputs a user's voice signal inputted through the microphone input unit 21.

In the conventional wireless microphone type karaoke adapting a modulation method based on a voice signal UHF transmission module (UHF TX module) 12, when a user's analog voice signal is modulated and transmitted in the wireless microphone, other noises are produced through the speaker together with the voice signal due to a certain interference phenomenon with respect to other frequencies of a UHF signal bandwidth. Therefore, it is impossible to fully reproduce the user's voice signals.

In addition, when the wireless microphone is adapted in the conventional karaoke device, it is fixed at a certain frequency bandwidth. In this case, a communication method between the wireless microphone and the karaoke device is fixed based on a 1:1 method, so that it is needed to change a frequency channel when other wireless microphones are supposed to be used for thereby causing much inconvenience in use.

In the conventional art, since the wireless microphone and karaoke remote controller are separated, the user is needed to directly control many keys provided at the remote controller, karaoke device, and amplifier while the user sings a song in order to set a karaoke function such as tone, rhythm, male or female conversion key, song word skipping, etc., and an amplifier function such as volume control, tone control, echo control, etc. Therefore, there are many inconveniences in use because the singer cannot concentrate on singing the songs.

### SUMMARY OF THE INVENTION

Accordingly, it is an object of the present invention to overcome the above-described problems encountered in the conventional art.

It is another object of the present invention to provide a digital wireless microphone having song (title) selection and amplifier control functions in a karaoke device, and a karaoke system using the same in which it is possible to produce a clear sound signal through a speaker in such a manner that a wireless microphone and a karaoke device are constituted based on a digital signal process method of a CDMA that uses a 2.4 GHz, 5.8 GHz bandwidth, so that a natural voice signal of a user who sings along an orchestra is transmitted without ant interference of a frequency.

It is further another object of the present invention to provide a digital wireless microphone having song selection and amplifier control functions in a karaoke device, and a karaoke system using the same that are capable of preventing natural voice signals from being outputted together with unnecessary noises of other bands by encoding analog waveform voice signals into digital signals using a wireless microphone and transmitting the same, and decoding the digital signals transmitted from the wireless microphone in a karaoke device for thereby clearly playing natural voice signals.

It is still further another object of the present invention to provide a digital wireless microphone having song selection and amplifier control functions in a karaoke device, and a karaoke system using the same in which a plurality of wireless microphones can be automatically connected with one karaoke device in a method that an inherent ID information of each microphone are recognized in a CDMA method, and a corresponding wireless microphone signal is separated and played.

It is still further another object of the present invention to provide a digital wireless microphone having song selection and amplifier control functions in a karaoke device, and a karaoke system using the same in which peripherals installed in one karaoke room can be controlled using one wireless microphone by installing a function operation button and an amplifier function button of a karaoke device in a wireless microphone, so that a user does not need to directly operate a remote controller, a karaoke device, an amplifier, etc.

To achieve the above objects, according to an embodiment of the present invention, there is provided a digital wireless microphone having song selection and amplifier control functions in a karaoke device, comprising a microphone for converting a voice signal of a user who sings a song along a song accompaniment outputted through a speaker, into an electrical signal; a key input unit for receiving a key signal used for a selection data of a song that a user wants to sing, a song accompaniment function control, and an amplifier operation control; a digital conversion module for converting a user's voice signal inputted from the microphone into a digital signal and outputting the digital signal; a function process CPU for encoding a key signal inputted from the key input unit and a digital voice signal inputted from the digital conversion module into one signal and outputting the converted signal; and a wireless transmission module for transmitting the digital signal inputted from the function process CPU to the karaoke device in a CDMA method using a spread code, wherein the wireless microphone karaoke reverse-spreads a signal transmitted from the digital wireless microphone and demodulates the signal for thereby extracting a digital signal, and the wireless microphone karaoke decodes the digital signal and separates into a digital voice signal and a control signal, and converts a digital data corresponding to a voice signal into an analog voice signal for thereby outputting through the speaker, and the wireless microphone karaoke device performs a function control and an amplifier control corresponding to the decoded karaoke function control signal and amplifier operation control signal.

At this time, the digital conversion module includes a CPU for controlling a process that a user's voice signal of an analog waveform inputted from the microphone is converted into a digital signal; an ADC for converting a user's voice signal of an analog waveform inputted from the microphone into a digital signal in accordance with a control of the CPU and outputting to the function process CPU; and a RAM for storing a driving program used for a digital conversion.

To achieve the above objects, according to another embodiment of the present invention, in a karaoke system used for converting a voice signal of an analog waveform of a user who sings a song along a song accompaniment into a digital signal, transmitting the digital signal, playing the signals as sound through a speaker connected with a karaoke device and outputting the signals, there is provided a karaoke system using a digital wireless microphone having song selection and amplifier control functions in a karaoke device, comprising a digital wireless microphone that includes an input button for a song selection, a song accompaniment function control and an amplifier operation control and is used for converting an analog voice signal of a user who sings a song into a digital signal, encoding a user's voice signal converted into a digital signal and a control signal inputted by the user, and transmitting the signal in a CDMA method (spread process) using a previously set spread code; a karaoke device that controls displaying a background screen and a song word on a certain display device such as a television set, etc., playing and outputting a sound source data of a certain song selected by a user and a user's voice signal, and reverse-spreads a signal transmitted from the digital wireless microphone, and demodulates the signal for thereby extracting a digital signal, and decodes the signal and separates the signal into a digital voice signal and a control signal, converts a digital data corresponding to a voice signal into an analog voice signal and outputs through the speaker, and performs a function control and amplifier control corresponding to the decoded karaoke function control signal and amplifier operation control signal; and an amplifier that is connected with the karaoke device through a communication cable and controls an amplifier function in accordance with an amplifier operation control signal inputted from the karaoke device.

At this time, the karaoke device includes a wireless receiving module for reverse-spreading a signal transmitted from the wireless transmission module of the digital wireless microphone using a spread code, demodulating the signal and outputting a digital signal; a signal separation CPU for decoding a digital signal inputted from the wireless receiving module and separating a user's voice signal, a song selection data, a karaoke function control signal and an amplifier control signal and outputting the separated signals; an analog conversion module for converting a user's voice signal inputted from the signal separation CPU into an analog signal and outputting the analog signal; a karaoke controller for controlling outputting a song accompaniment based on a song selection data inputted from the signal separation CPU and outputting a background screen or a song word on a certain display device such as a television set, etc. and performing the controls in accordance with a song karaoke function control signal inputted from the signal separation CPU; and a mixer controller for controlling a playing song accompaniment function in accordance with a control of the karaoke controller, mixing with a user's voice signal of an analog waveform inputted from the analog conversion module and outputting through the speaker and outputting a background screen or a song word on a certain display device in accordance with a control of the karaoke controller.

### BRIEF DESCRIPTION OF THE DRAWINGS

The present invention will become better understood with reference to the accompanying drawings which are given only by way of illustration and thus are not limitative of the present invention, wherein;

FIG. 1 is a block diagram illustrating an analog signal process device of a voice signal in a conventional wireless type microphone karaoke system;

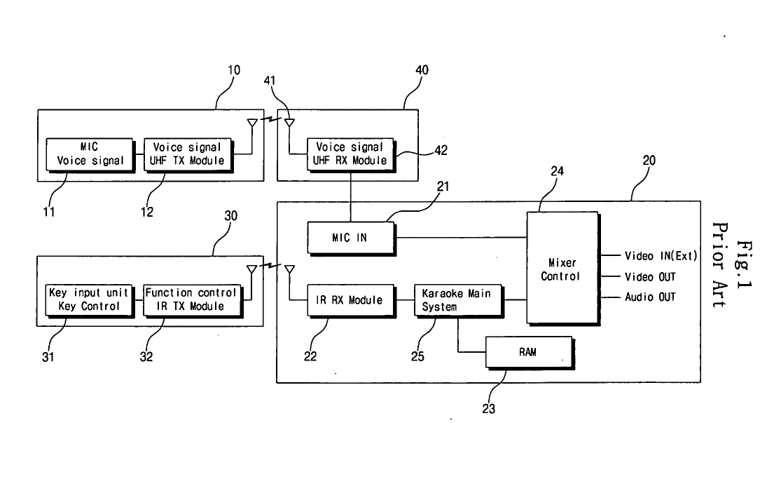

FIG. 2 is a schematic view of a karaoke system according to the present invention; and

FIG. 3 is a block diagram illustrating a digital signal process device of a voice signal and a control signal of a karaoke system using a digital wireless microphone according to the present invention.

### DETAILED DESCRIPTION OF THE PREFERRED EMBODIMENTS

The digital wireless microphone having song selection and amplifier control functions in a karaoke device, and a karaoke system using the same according to the present invention will be described with reference to the accompanying drawings.

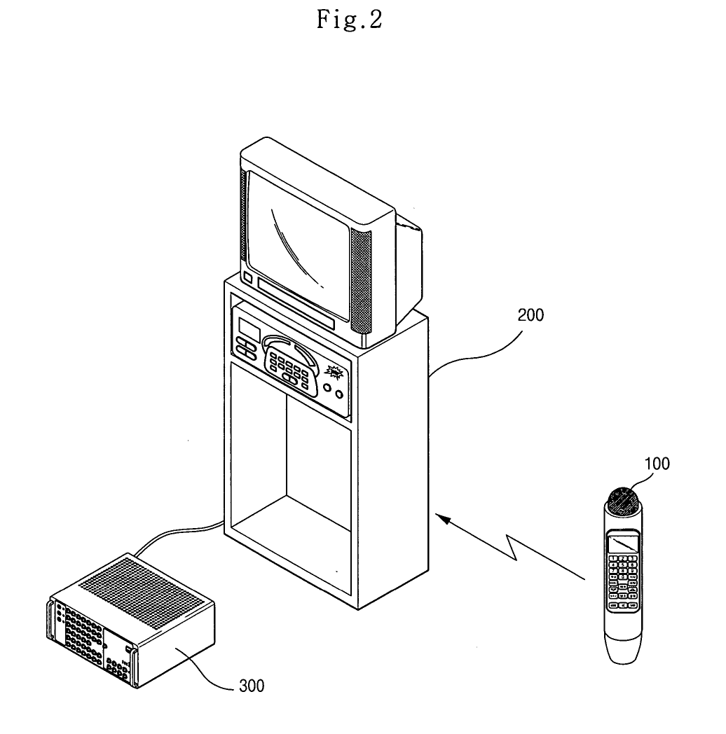

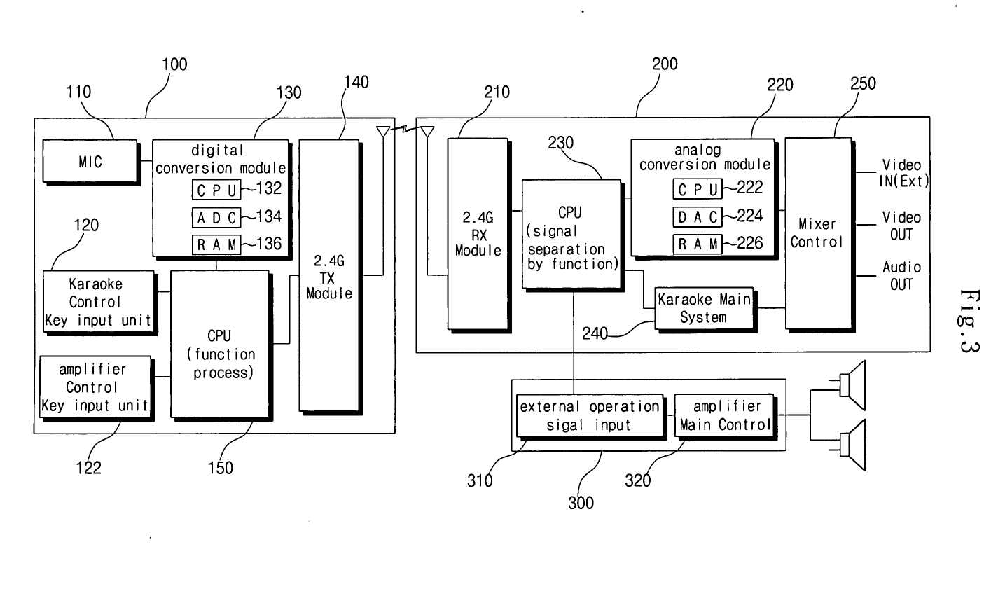

FIG. 2 is a schematic view of a karaoke system according to the present invention, and FIG. 3 is a block diagram illustrating a digital signal process device of a voice signal and a control signal of a karaoke system using a digital wireless microphone according to the present invention.

As shown in FIG. 2, a karaoke system according to the present invention includes a digital wireless microphone 100, a karaoke device 200, and an amplifier 300.

The operations of the karaoke system formed of a digital wireless microphone, a karaoke device, and an amplifier according to a preferred embodiment of the present invention will be described with reference to FIG. 3.

As shown therein, the digital wireless microphone 100 is designed to use a CDMA digital signal process method of 2.4 GHz, 5.8 GHz bandwidths. The digital wireless microphone 100 includes various keys for a song selection and a function control of the karaoke device 200. A voice signal of a user who sings a song is converted into a digital signal. A function control signal used for setting various function operations (for example, karaoke basic functions such as start, stop, song reservation, etc., applied functions such as melody selection, rhythm speed control, volume control, echo effect, etc.) of the karaoke device 200 and a user's voice signal converted into a digital signal are encoded and modulated. The thusly encoded and modulated signals are transmitted to the karaoke device 200 based on the CDMA method in which a spread code is additionally included and converted into broadband width signals.

At this time, the digital wireless microphone 100 includes a microphone 110 for converting a voice signal of a user who sings a song along an accompaniment of the karaoke device outputted through the speaker connected with the karaoke device 200 into an electrical signal, a karaoke control key input unit 120 and an amplifier control key input unit 122 for receiving a selection data of a song that a user wants to sing and a key signal for various function controls of the karaoke device 200, a digital conversion module 130 for converting a user voice signal of an analog waveform inputted from the microphone 110 based on a chip set adapted to a digital conversion of analog signal into a digital signal, a function process CPU 150 for encoding a song selection data or various function control signals inputted from the key input unit 120 and a user's voice signal converted into digital signal into one signal, and a wireless transmission module (2.4G TX module) 140 for providing the signal encoded by the function process CPU 150 with a spread code and transmitting to the karaoke device 200 based on the CDMA method.

The digital conversion module 130 includes a CPU 132 for controlling a digital conversion of a user's voice signal of an analog waveform inputted from the microphone 110, an ADC (Analog to Digital Converter) 134 for converting an user's voice signal of an analog waveform inputted from the microphone 110 into a digital signal in accordance with a control of the CPU 132 and outputting to the function process CPU 150, and a RAM 136 for storing a driving program used for a digital conversion.

Here, the karaoke device 200 controls the functions that a background screen and a song word are displayed on a certain displace device such as a television set connected through a cable, and a sound source data of a song selected by a user is outputted trough a speaker. In addition, the karaoke device 200 receives a signal transmitted from the digital wireless microphone 100 based on the CDMA method and reverse-spreads the received signal using the same code as the spread code used during the transmission and demodulates and decodes the signal, for thereby separating a digital signal corresponding to the user's voice signal and song selection data. Thereafter, the karaoke device 200 converts the digital signal corresponding to the user's voice signal into an analog signal and outputs the converted analog signal through the speaker. The karaoke device 200 further performs operation controls in accordance with various function operation control signals.

At this time, the karaoke device 200 includes a wireless receiving module (2.4G RX module) 210 for reverse-spreading the signal transmitted from the wireless transmission module (2.4G TX module) 140 of the digital wireless microphone 100 using a spread code and demodulating the signal for thereby outputting a digital signal, a signal separation CPU 230 for decoding a digital signal inputted from the wireless receiving module (2.4G RX module) 210 and separating a user's voice signal, a song selection data and various function control signals, an analog conversion module 220 for converting a digital data corresponding to the separated user's voice signal into an analog signal for hereby outputting an original signal, a karaoke controller 240 for outputting a song accompaniment sound to a mixer controller 250 in accordance with a song selection data inputted from the signal separation CPU 230, controlling outputting a background screen or a song word on a certain display device such as a television set, etc., and controlling the mixer controller in accordance with a song karaoke function control signal inputted from the signal separation CPU 230, and a mixer controller 250 for adjusting a song accompaniment sound outputted and mixing with a user's voice signal of an analog waveform inputted from the analog conversion module 220 in accordance with a control of the karaoke controller 240, outputting through the speaker and displaying a background screen or a song word on a certain display device in accordance with a control of the karaoke controller 240.

The analog conversion module 220 includes a CPU 222 for reverse-spreading in the wireless receiving module (2.4G RX module) 210 using the spread code and controlling a conversion from the demodulated digital signal into an analog signal, a DAC (Digital to Analog Converter) 224 for converting a digital signal corresponding to a user's voice signal in accordance with a control of the CPU 222 and outputting to the mixing controller 250, and a RAM 226 for storing a driving program used for an analog conversion.

The digital wireless microphone 100 has a certain serial number. When a certain data is transmitted from the wireless microphone to the karaoke device 200, a channel encoding based on the microphone serial number is performed in the karaoke device 200, so that a user's voice is outputted, so that a plurality of digital wireless microphones 100 can be connected with one karaoke device 200 without additionally setting a channel.

Namely, even when a plurality of the digital wireless microphones 100, not one digital wireless microphone, are used, since the karaoke device 200 is capable of separating the signal of each digital wireless microphone 100 based on a serial number of the digital wireless microphone 100 and outputting the separated signal, it is not needed to manually designate the channel based on each digital wireless microphone 100.

Next, the operation of the digital signal process device of a voice signal and an operation signal of the wireless microphone karaoke according to the present invention will be described.

When a user selects a desired song or a function control by operating keys provided at the digital wireless microphone 100, the digital wireless microphone 100 transmits a corresponding selection data or a function setting data to the karaoke device 200. The karaoke device 200 plays and outputs a corresponding song through the speaker based on the selection data or function setting data set by the user.

When an accompaniment sound corresponding to the selected song is outputted from the speaker, the user sings along the accompaniment sound using the digital wireless microphone 100. At this time, the user's voice signal inputted through the microphone 110 is encoded into a digital signal by the digital conversion module 130, and the wireless transmission module (2.4G TX module) 140 transmits to the karaoke device 200 in the CDMA method based on a previously set spread code.

The karaoke device 200 reverse-spreads the signal received from the digital wireless microphone 100 through the wireless receiving module (2.4G RX module) using the same spread code and demodulates the signal for thereby extracting a digital signal, and the signal separation CPU 230 decodes the digital signal inputted from the wireless receiving module (2.4G RX module) 210 for thereby separating a user's voice signal and function control signal. The user's voice signal is outputted to the analog conversion module 220, and the function control signal is outputted to the karaoke controller 240. The analog conversion module 220 converts a user's digital voice signal into an analog signal and outputs to the mixer controller 245.

In addition, the user's analog signal of an analog waveform mixed through the mixer controller 250 is outputted through the speaker, and the users can listen to a clear user's voice signal through the speaker without any noises when using the digital wireless microphone 100.

Namely, the digital wireless microphone 100 encodes a user's voice signal of an analog waveform into a digital signal, and performs a spread process using a previously set spread code in the CDMA method, and outputs the processed signal. The karaoke device 200 reverse-spreads the received signal in the CDMA method, and demodulates and decodes the signal. Therefore, in the present invention, it is possible to output a clear user's voice signal without any interference in frequencies as compared to the conventional art.

The karaoke controller 240 controls a function of the karaoke device 200 based on a function control signal inputted from the signal separation CPU 230, so that a song accompaniment sound adjusted based on a user's selection is outputted to the speaker through the mixer controller 250.

As described above, according to the digital wireless microphone having song selection and amplifier control functions in a karaoke and a karaoke system using the same according to the present invention, the wireless microphone and karaoke device are constructed based on a CDMA signal process method of 2.4 GHz, 5.8 GHz broadband widths. A natural user's voice signal is digitally processed and transmitted. The karaoke decodes the digitally processed signals and outputs and only user's original voice signals. Therefore, it is possible to output a clear user's voice signal without any noises due to frequency interferences of other broadband widths for thereby enhancing the satisfaction of users who use the karaoke device according to the present invention.

When a plurality of wireless microphones are connected with one karaoke device, it is not needed to manually designate by the channels. Namely, a signal of each wireless microphone is separated and outputted as sound, so that it is possible to achieve one-to-multiple connections as compared to the conventional art having one-to-one connection method.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A digital wireless microphone having song (title) selection and amplifier control functions in a karaoke device, comprising:
a microphone for converting a voice signal of a user who sings a song along a song accompaniment outputted through a speaker, into an electrical signal;
a key input unit for receiving a key signal used for a selection data of a song that a user wants to sing, a song accompaniment function control, and an amplifier operation control;
a digital conversion module for converting a user's voice signal inputted from the microphone into a digital signal and outputting the digital signal;
a function process CPU (Central Processing Unit) for encoding a key signal inputted from the key input unit and a digital voice signal inputted from the digital conversion module into one signal and outputting the converted signal; and
a wireless transmission module for transmitting the digital signal inputted from the function process CPU to the karaoke device in a CDMA method using a spread code,
wherein the wireless microphone karaoke reverse-spreads a signal transmitted from the digital wireless microphone and demodulates the signal for thereby extracting a digital signal, and the wireless microphone karaoke decodes the digital signal and separates into a digital voice signal and a control signal, and converts a digital data corresponding to a voice signal into an analog voice signal for thereby outputting through the speaker, and the wireless microphone karaoke performs a function control and an amplifier control corresponding to the decoded karaoke function control signal and amplifier operation control signal.

2. The microphone of claim 1, wherein said digital conversion module includes:
a CPU for controlling a process that a user's voice signal of an analog waveform inputted from the microphone is converted into a digital signal;
an ADC (Analog to Digital Converter) for converting a user's voice signal of an analog waveform inputted from the microphone into a digital signal in accordance with a control of the CPU and outputting to the function process CPU; and
a RAM (Random Access Memory) for storing a driving program used for a digital conversion.

3. In a karaoke system used for converting a voice signal of an analog waveform of a user who sings a song along a song accompaniment into a digital signal, transmitting the digital signal, playing the signals as sound through a speaker connected with a karaoke device and outputting the signals, a karaoke system using a digital wireless microphone having song selection and amplifier control functions in a karaoke device, comprising:
a digital wireless microphone that includes an input button for a song selection, a song accompaniment function control and an amplifier operation control and is used for converting an analog voice signal of a user who sings a song into a digital signal, encoding a user's voice signal converted into a digital signal and a control signal inputted by the user, and transmitting the signal in a CDMA method (spread process) using a previously set spread code;
a karaoke device that controls displaying a background screen and a song word on a certain display device such as a television set, etc., playing and outputting a sound source data of a certain song selected by a user and a user's voice signal, and reverse-spreads a signal transmitted from the digital wireless microphone, and demodulates the signal for thereby extracting a digital signal, and decodes the signal and separates the signal into a digital voice signal and a control signal, converts a digital data corresponding to a voice signal into an analog voice signal and outputs through the speaker, and performs a function control and amplifier control corresponding to the decoded karaoke function control signal and amplifier operation control signal; and
an amplifier that is connected with the karaoke device through a communication cable and controls an amplifier function in accordance with an amplifier operation control signal inputted from the karaoke device.

4. The system of claim 3, wherein said digital wireless microphone includes:
a microphone for converting a voice signal of a user who sings a song along a song accompaniment outputted through a speaker into an electrical signal;
a key input unit for receiving a key signal used for a song selection data that a user wants to sing, a karaoke function control and an amplifier operation control;
a digital conversion module for converting a user's voice signal inputted from the microphone into a digital signal and outputting the digital signal;
a function process CPU for encoding a key signal inputted from the key input unit and a digital voice signal inputted from the digital conversion module into one signal and outputting the signal; and
a wireless transmission module for transmitting a digital signal inputted from the function process CPU to the karaoke device in a CDMA method using a spread code.

5. The system of claim 4, wherein said digital conversion module includes:
a CPU for controlling a user's voice signal of an analog waveform inputted from the microphone into a digital signal;
an ADC for converting a user's voice signal of an analog waveform inputted from the microphone into a digital signal in accordance with a control of the CPU and outputting to the function process CPU; and
a RAM for storing a driving program used for a digital conversion.

6. The system of claim 3, wherein said karaoke device includes:
a wireless receiving module for reverse-spreading a signal transmitted from the wireless transmission module of the digital wireless microphone using a spread code, demodulating the signal and outputting a digital signal;
a signal separation CPU for decoding a digital signal inputted from the wireless receiving module and separating a user's voice signal, a song selection data, a karaoke function control signal and an amplifier control signal and outputting the separated signals;
an analog conversion module for converting a user's voice signal inputted from the signal separation CPU into an analog signal and outputting the analog signal;
a karaoke controller for controlling outputting a song accompaniment based on a song selection data inputted from the signal separation CPU and outputting a background screen or a song word on a certain display device such as a television set, etc. and performing the controls in accordance with a song karaoke function control signal inputted from the signal separation CPU; and
a mixer controller for controlling a playing song accompaniment function in accordance with a control of the karaoke controller, mixing with a user's voice signal of an analog waveform inputted from the analog conversion module and outputting through the speaker and outputting a background screen or a song word on a certain display device in accordance with a control of the karaoke controller,
wherein said amplifier includes an operation control signal input unit for receiving an amplifier operation control signal from the signal separation CPU; and
an amplifier controller for controlling an operation of the amplifier in accordance with an amplifier operation control signal inputted through the operation control signal input unit.

7. The system of claim 6, wherein said analog conversion module includes:
a CPU for controlling an analog conversion of a digital data corresponding to a user's voice signal received from the signal separation CPU;
a DAC (Digital to Analog Converter) for converting a digital signal corresponding to a user's voice signal inputted from the signal separation CPU into an analog signal in accordance with a control of the CPU and outputting to the mixer controller; and
a RAM for storing a driving program used for an analog conversion.
